(19) United States
(12) Patent Application Publication
(10) Pub. No.: US 2007/0028521 A1
(43) Pub. Date: Feb. 8, 2007

(54) System for packaging and shipping flower bulbs

(76) Inventor: Dale LaCasse, Marlborough, NH (US)

Correspondence Address: DEVINE, MILLIMET & BRANCH, P.A., 111 AMHERST STREET, BOX 719, MANCHESTER, NH, 03105, US

(21) Appl. No.: 11/500,673

(22) Filed: Aug. 8, 2006

Related U.S. Application Data
(60) Provisional application No. 60/706,504, filed on Aug. 8, 2005.

(51) Int. Cl. A01G 9/02

(52) U.S. Cl. 47/84

(57) ABSTRACT

A system for packaging flower bulbs with sprouts and roots that both protects the sprouts and makes it easier to extract the bulbs from the packaging.

The instant application claims the benefit of U.S. Provisional Application Ser. No. 60/706,504 filed on Aug. 8, 2005

### TECHNICAL FIELD

The present invention relates to a system for packaging and shipping flower bulbs. More particularly, it is a system for commercial growers of flower bulbs to package and ship them to retailers and directly to consumers.

### BACKGROUND INFORMATION

A system is needed for packaging and shipping flower bulbs.

It is desirable for such a system to hold one or flower bulbs such that for each bulb the roots are in contact with moist soil (or soil substitute) and the sprout is up. The prior art includes examples of “egg-carton” designs in which each bulb is placed in a separate compartment, as in U.S. Pat. No. 2,930,162. The bottom of the so-called egg carton contains a bulb, its roots and moist soil (or soil substitute) in a separate compartment. The top of the so-called egg carton holds the bulb in each compartment in place while allowing the sprout of the bulb to protrude through an opening in the top. The prior art discloses such containers made from paraffin cardboard, plastic or other relatively rigid material.

The containers disclosed in the prior art have a number of drawbacks. The opening, in the top of the container, for the sprout of a bulb is often too small to accommodate the growth of the bulb. The sprout of the bulb can be damaged by the rigid material surrounding the opening. Various mechanisms have been suggested to allow the growing bulb to expand the opening. However, these mechanisms increase the chance that the sprout of the bulb will be “nicked,” which will not prevent blooming but will result in unsightly leaf damage, as is described in more detail below. Also, if the handling of the container during shipping is rough, a small opening may lead to damage to the sprout of the bulb. Alternatively, if the opening for the sprout of the bulb is too large, the bulb can shift during shipping contributing to damage to the sprout of the bulb or the soil in the compartment can escape.

Another drawback of the prior art is the extent to which the sprouts of the bulbs extend through the openings in the relatively thin top of the container and are unprotected.

Another drawback of the prior art is the difficulty of extracting the bulbs from the bottom of the container if the roots of the bulbs have grown sufficiently to exert pressure on the sides of the compartments in which the bulb pack is placed. Exerting the force on the foots pressing to remove the bulbs often damages the roots.

Still another drawback of the prior art is the weight of the containers, increasing the cost of shipping them.

It is the object of the present invention to mitigate the drawbacks of the prior art described above and to add the improvements described below.

### BRIEF DESCRIPTION OF THE DRAWINGS

These and other features and advantages of the present invention will be better understood by reading the following detailed description, taken together with the drawings wherein:

FIG. 1 is a top view of the base of the present invention;

FIG. 2 is a side view of the base of the present invention; and

FIG. 3 is a side view of the top and base of the present invention.

### DESCRIPTION OF THE INVENTION

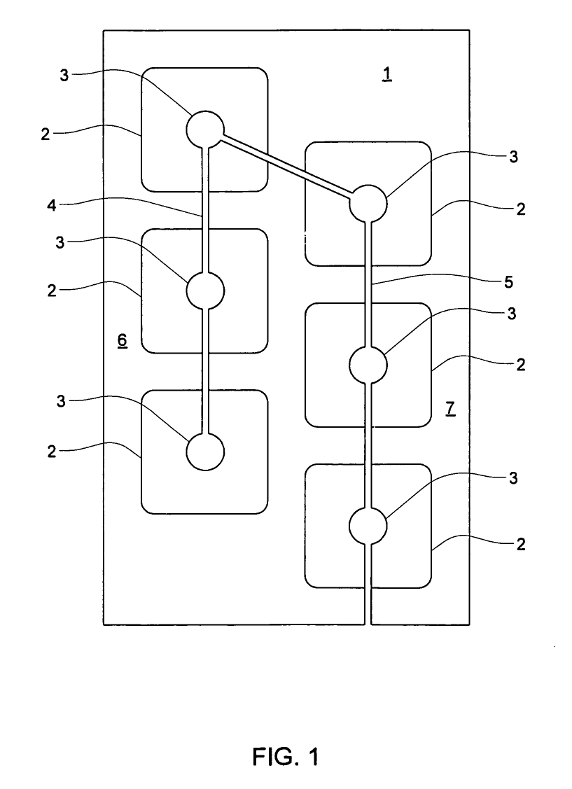

The system of the present invention includes a base and a top. The base is made of expanded polystyrene (EPS), or other lightweight rigid plastic. The base has one or more compartments and each compartment holds all or part of a bulb and its roots. A top view of one embodiment of the base of the present invention is shown in FIG. 1. The base 1 has six compartments 2. Each compartment, which in this embodiment is square in horizontal cross-section, has a hole 3 at the bottom.

The base is cut completely through along lines 4 and 5, with line 4 going from one side of the bottom through all three compartments on the first side 6 of the bottom 1 and line 5 going through all three compartments on the second side 7 of the base 1. A consumer may remove a bulb and its roots from a compartment 2 by pushing up through the hole 3 in the bottom of the compartment 2. In addition, if the removal of a bulb and its roots is difficult, the consumer may easily break away either or both the first side 6 and the second side 7 to remove the bulbs and their roots from the base without risk of damage to the bulbs and their roots.

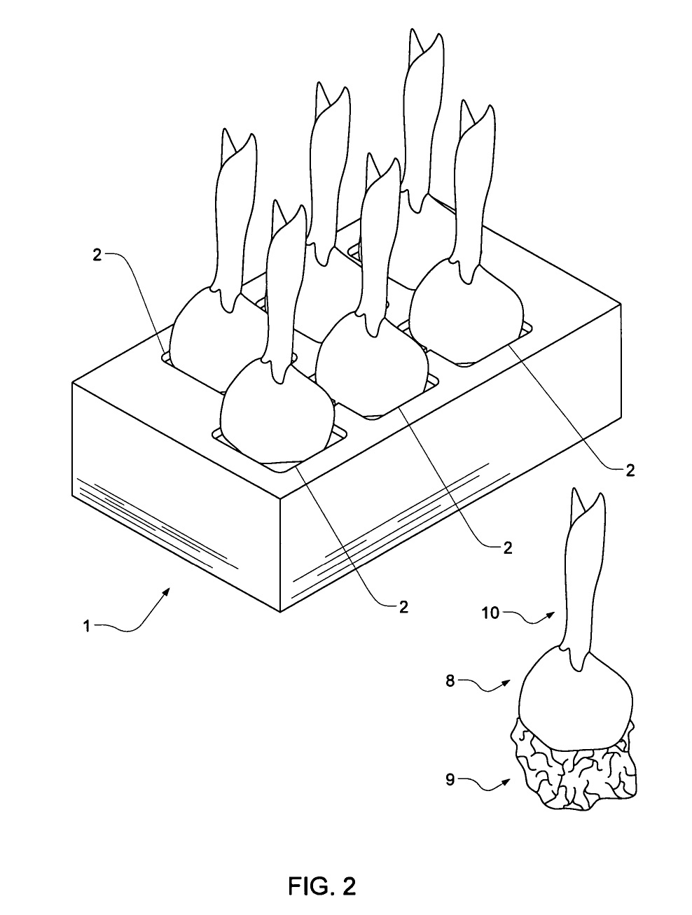

FIG. 2 also illustrates a preferred embodiment of the base of the present invention. The base 1 is shown with six compartments 2 for bulbs, each of which compartment 2 is holding a bulb and its roots. Each compartment also holds moist soil (or a soil substitute), which is not shown. A separate bulb 8 and its roots 9 and sprout 10 are also shown.

The present invention also includes a top of polyurethane (P/U), or other soft formable plastic foam. The top secures the bulbs and the roots in the compartments in the base. The top, which is thick enough to contain most, of not all of the length of the sprout of the bulb, also adds protection to the sprout.

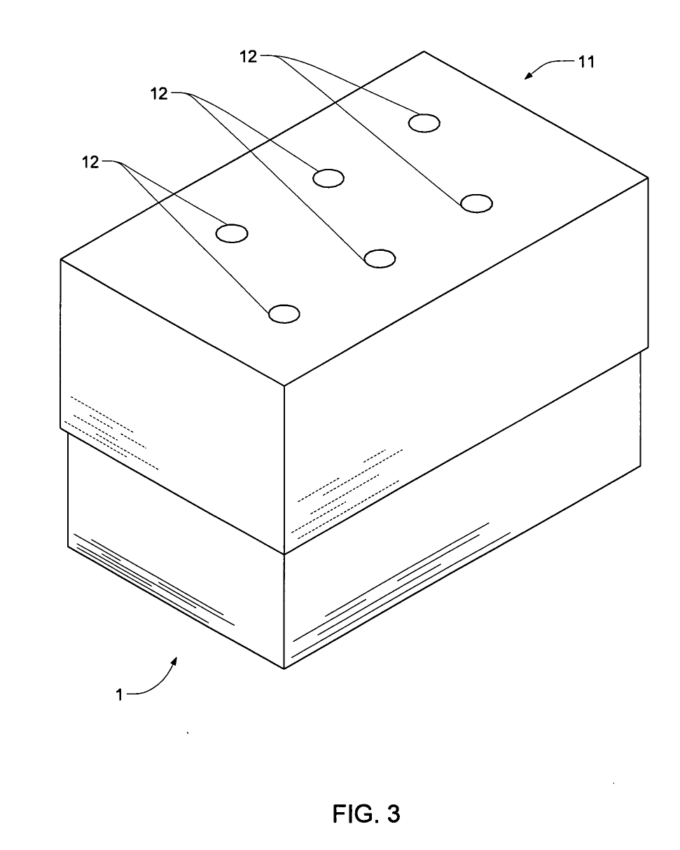

As is shown in FIG. 3, a preferred embodiment of the top 11 is placed on top of the base 1. The formable plastic foam of the top 11 has six holes 12, into which the sprouts of the bulbs in compartments 2 in the base 1 extend. The holes 12 in the top 11 can be custom sized to the type of bulb to be shipped. The top 11 conforms to each bulb providing a secure fit, holding the bulb in place and not allowing any soil to escape. Moreover, as the plastic foam of the top 11 is much softer than the packaging of the prior art, insuring that damage to the bulbs and their sprouts is minimized. In addition, the top 11 encases most, if not all of the sprouts of the bulbs, further protecting them against damage. Such damage includes “nicking” of the sprouts. “Nicking” does not prevent the bulb from blooming but causes unsightly leaf damage on the first large leaf that appears, especially on tulips. The softer and thicker top 11 insures the delivery of a higher quality product.

In use, the top 11 is placed over the bulbs and roots in base 1 and the two parts are then placed in a shipping carton, in one preferred embodiment a sleeve of cardboard. The shipping carton holds the top 11 and base 1 together securely, eliminating the need for any other means to secure them together. This saves weight and makes removing the bulbs easier. The top 11 and base 1 are removed from the carton and the top 11 is lifted off. The bulbs are easily removed from the base 1 as described above in detail. This also reduces any damage that might result from removal of the bulbs.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A system for packaging one or more flower bulbs, wherein each bulb has roots and a sprout, comprising,
a base made of a relatively lightweight rigid material with one or more compartments such that each compartment holds all or part of a bulb and its roots; and
a top made of formable plastic foam, with holes through the top into which the sprouts of the bulbs in the base extend when the top is placed on the base, such that the top conforms to the bulbs in the base and holds the bulbs in place.

2. The system of claim 1 wherein the top is thick enough to contain most, or all, of the length of the sprouts of the bulbs in the base.

3. The system of claim 1 wherein each compartment containing a bulb also contains soil or a soil substitute.

4. The system of claim 1 further comprising a means securely to hold the top and bottom together.

5. The system of claim 1 wherein the base has one or more sides and is cut completely through along one or more lines extending from one or more sides of the base through one or more successive adjacent compartments, thereby making it possible easily to break the base into pieces.

6. A method for packaging one or more flower bulbs, wherein each flower bulb has roots and a sprout, comprising,
placing one or more bulbs into one or more compartments in a base made of a relatively lightweight rigid material; and
placing a top on the base, wherein the top is made of formable plastic foam with holes through the top into which the sprouts of the bulbs in the base extend, such that the top conforms to the bulbs in the base and holds the bulbs in place.

7. The method of claim 6 wherein the top is thick enough to contain most, or all, of the length of the sprouts of the bulbs in the base.

8. The method a claim 6 wherein each compartment containing a bulb also contains soil or a soil substitute.

9. The method of claim 6 further comprising securely holding the top and the bottom together.

10. The method a claim 6 wherein the base has one or more sides and the base is cut completely through along one or more lines extending from one or more sides of the base through one or more successive adjacent compartments, making it possible easily to break the base in pieces.
